(19) United States
(12) Patent Application Publication
(10) Pub. No.: US 2008/0036799 A1
(43) Pub. Date: Feb. 14, 2008

(54) Processes for printing arrays of substantially parallel lines

(76) Inventor: Steven Dale Ittel, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/390,541

(22) Filed: Mar. 23, 2006

Related U.S. Application Data
(60) Provisional application No. 60/665,135, filed on Mar. 25, 2005.

(51) Int. Cl. B41J 3/407; B41J 2/045

(52) U.S. Cl. 347/2; 347/68

(57) ABSTRACT

The present invention is directed to a process for combining spin printing and ink jet printing to print a plurality of largely parallel conductors, insulators, dielectrics, phosphors, emitters, and other elements that can be for electronics and display applications. The present invention also relates to a device used in this printing process. The present invention further includes devices made thereby.

This application claims the benefit of U.S. Provisional Application No. 60/665,135, filed on Mar. 25, 2005.

### FIELD OF THE INVENTION

The present invention is directed to process for combining spin printing and ink jet printing to print a plurality of lines of conductors, insulators, dielectrics, phosphors, emitters, and other active elements that are substantially parallel. The present invention also includes devices useful in the printing process, and devices made using the processes and devices.

### TECHNICAL BACKGROUND

The electronics, display and energy industries rely on the formation of coatings and patterns of conductive and other electronically active materials to form circuits on organic and inorganic substrates. The primary methods for generating these patterns are screen printing for features larger than about 100 μm and thin film and etching methods for features smaller than about 100 μm. Other subtractive methods to attain fine feature sizes include the use of photo-patternable pastes and laser trimming.

In a number of these applications, the patterns consist of a plurality of fine, parallel conductive lines terminated at the ends with contact pads for assuring simple electrical contact with connectors to external circuitry. The terminator pads generally constitute less than one percent of the length of the lines that are otherwise parallel. Examples of this pattern are to be found in display devices such as plasma display panels or liquid crystal displays. They are to be found in touch screen devices and in the displays of a variety of hand-held electronic devices. Electromagnetic interference shielding will often have similar arrays of parallel lines with perpendicular interconnects between the lines and a grounding contact pad. In these applications, the lines are substantially parallel with occasional interconnections between the lines. Photovoltaic devices have very fine parallel electrical leads running in one direction connected to higher power busses running in the perpendicular direction.

It is the trend in the electronics industry to make smaller and less expensive electronic devices. It is the trend in the display industry to provide higher resolution and enhanced display performance at continuously lower cost. As a result of these trends, it has become necessary to develop new materials and new approaches to manufacture such devices.

Photo-patterning technologies offer uniform finer lines and space resolution when compared to traditional screen-printing methods. A photo-patterning method, such as DuPont's FODEL® printing system and thick film pastes, utilizes a photoimageable organic medium as found in patents U.S. Pat. No. 4,912,019; U.S. Pat. No. 4,925,771; and U.S. Pat. No. 5,049,480, whereby the substrate is first completely covered (printed, sprayed, coated or laminated) with the photoimageable thick film composition and dried. An image of the circuit pattern is generated by exposure of the photoimageable thick film composition with actinic radiation through a photomask bearing a circuit pattern. Actinic radiation is radiation such as ultraviolet that can cause photochemical reactions. The exposed substrate is then developed. The unexposed portion of the circuit pattern is washed away leaving the photoimaged thick film composition on the substrate that, subsequently, is fired to remove all remaining organic materials and sinter inorganic materials. Such a photo-patterning method demonstrates line resolution of about 30 microns depending on the substrate smoothness, inorganic particle size distribution, exposure, and development variables. When employed for the production of conductors in display devices such as plasma display panels, field emission displays, or liquid crystal displays, the conducting lines can be up to a meter long, many orders of magnitude longer than their widths and precision. The process is necessarily subtractive in its nature as a result of the washout of a large portion of the pattern. A process that is additive is desired by those in the industry.

Ink jet printing systems are touted as high resolution, digitally-controlled, additive, printing systems. They have the ability to print complex patterns through digital instructions with good resolution. Ink jet printing systems are digital recording system that comprises the step of printing by discharging ink drops through a discharge orifice such as a nozzle or a slit to thus make the ink drops directly adhere to a printing substrate. Ink jet techniques can usually fall into two broad categories: continuous injection systems and on-demand systems. In continuous injection systems, the ink jet is firing a continuous stream of microdrops and the pattern is established by selectively diverting or not diverting those microdrops to a waste reservoir. Thus it cannot be viewed, as fully additive in that the portion of material diverted to the reservoir is lost, making the process less than 100% additive. In the on-demand system, drops are fired only when required. These systems are more prone to clogging when employing inks with high solids content, and it is a common feature that the first several drops of high-solids inks may not reliably fire upon demand.

In the field of ink jet printing systems for conductive inks, a liquid dispersion of ultrafine metal particles has been used in the formation of a conductive circuit making use of the ink jet printing system (US patent application 2003/0110978 A1). Liquid dispersions of other ultrafine particles such as metal oxides, organometallics or polymers can also be used in the formation of components of electronic circuits or display devices using ink jet printing systems.

Ink jet printing delivers the metal containing ink in picoliter increments. While quite well suited to the digital printing of complex patterns, it is not a particularly high-speed process due to the low delivery rate of ink. The digital utility of ink jet printing is largely lost in the printing of long straight narrow conductor lines for displays. Ink jet inks, by the nature of the printing process, must be low viscosity fluids for proper operation of the jetting system. It is difficult to suspend high volumes of the conducting particles in the ink, and as a result, to obtain the high thicknesses of conductor required for high conductivity. It is usually necessary to print multiple passes, building up the thickness in each pass. Drying time or some other means for stabilizing the initial feature is required between passes. Resolution is often compromised and it is difficult to obtain appreciable feature height to feature width because non-viscous, wetting fluids are employed.

A process of spin printing, suitable for the printing of long straight conductors, is disclosed in patent application US2005-0089679. In spin printing, dissolution of an ultrahigh molecular weight polymer in a solvent yields a highly viscoelastic solution that is used as a medium for the printing of lines. The inks can be highly loaded with conductive materials such as silver, copper, nickel, carbon, or other species. Forcing the ink through a spin jet and then drawing yields a very fine filament that is then laid onto a substrate surface. The technique is high speed and gives high conductivity lines in a single or multiple passes. The negative feature of spin printing is that it is best suited to high speed printing of long, straight lines. It does not easily turn corners, nor does it easily allow the printing of additional features on the line.

Despite the foregoing advances in such systems, manufacturers are continuously seeking compositions with improved utility of the ultrafine materials and finer resolution of lines and spaces. Such materials will increase the speed of the manufacturing processes without compromising high resolutions in the lines and spaces of the circuit or display patterns. The present disclosure is directed to such a process, the hardware necessary for said process and devices manufactured by said process.

Spin printing and ink jet printing are complementary techniques and it is advantageous to combine the positive features of both for printing devices having some small features in addition to long straight features. It is further advantageous to combine these two printing techniques into a single device to do all of the printing in a single pass, thereby eliminating the difficulties of multiple steps and re-registration in moving from one device to another.

### SUMMARY OF THE INVENTION

One aspect of the present invention is a process for creating an image on a substrate comprising:

A. Spin printing, comprising
a) continuously forcing a deposit composition comprising between 20 and 80 percent by weight of functional phase particles, a dispersing vehicle, and between 0.1 and 8 percent by weight of an ultrahigh molecular weight polymer soluble in that dispersing vehicle through an orifice to form a filament
b) optionally elongating that filament;
c) depositing that filament on the substrate;

B. Inkjetting, comprising
d) dropwise ejecting an ink composition comprising between 20 and 70 percent by weight of functional phase particles, a dispersing vehicle, and between 1 and 10 percent of dispersant polymer,
e) depositing those drops on the substrate, and

C.
f) evaporating the dispersing vehicle from the deposited filament and droplets resulting in the functional phase particles being affixed to the substrate in the desired image.
g) and optionally heating the substrate and deposited image to a temperature sufficient to effect removal of the organic components.
   wherein A and tB can be conducted in any order and can be repeated several times before conducting C.

Another aspect of the present invention is an apparatus for creating an image on a substrate comprising a bed with one or more gantries, each gantry bearing
a) a spin printing section consisting of a plurality of precisely-positioned spin jets mounted on the gantry supported above the bed of the apparatus,
b) an inkjet printing section consisting of a plurality of precisely-positioned ink jets mounted on the gantry supported above the bed of the apparatus,
the bed bearing a transport mechanism for transporting the substrate in a direction perpendicular to the direction of the gantries, the gantries spanning the transport mechanism, and optionally a heating or drying section.

### BRIEF DESCRIPTION OF THE DRAWINGS

FIG. 1. Schematic representation of the apparatus for combined spin printing and ink jet printing

FIG. 2. Schematic representation of the co-alignment of the spin printing and ink jet printing orifices with respect to machine direction.

FIG. 3. Schematic representation of a section of the underside of the gantry showing the co-alignment of the spin jetting and ink jet printing orifices with respect to machine direction but with offset in the spin jets.

FIG. 4. Schematic representation of the adjacent alignment of the spinprinting and ink jet printing orifices with respect to machine direction.

### DETAILED DESCRIPTION

The process described herein is based upon spin printing technology that has been described in the copending application published as US2005-0089679, which is incorporated herein by reference in its entirety. The ink jetting of inks is well known to those skilled in the art. Application of ink jet technology to the printing of conductors and other electronic circuitry has been an area of intensive investigation.

When an amount, concentration, or other value or parameter is recited herein as either a range, preferred range or a list of upper preferable values and lower preferable values, the recited amount, concentration, or other value or parameter is intended to include all ranges formed from any pair of any upper range limit or preferred value and any lower range limit or preferred value, regardless of whether such ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

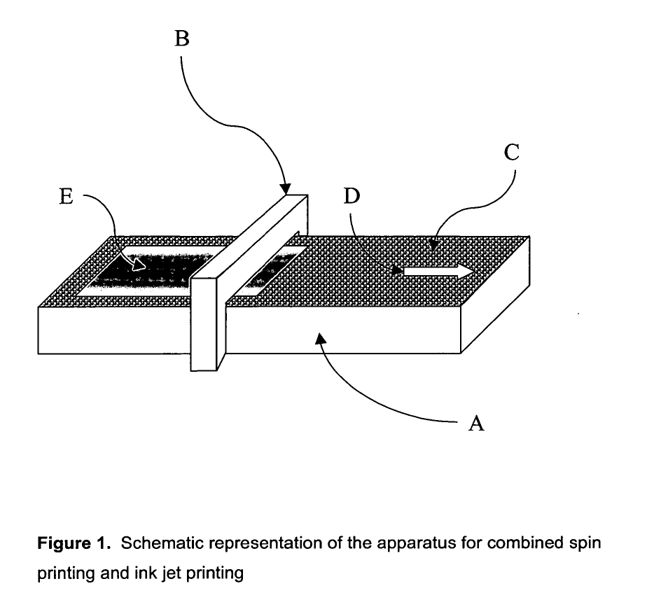

One embodiment of an apparatus according to the present invention is shown in FIG. 1. The bed of the apparatus (A) is topped with a gantry (B) and a mechanism (C) for transporting the substrate (E) beneath the gantry (B). As shown, the substrate is in motion in the machine direction (D) and the gantry is fixed, but the opposite could be true, so long as the gantry and the substrate move relative to one another. The gap between the top of the substrate and the apparatus on the underside of the gantry will be between a few millimeters and a few centimeters.

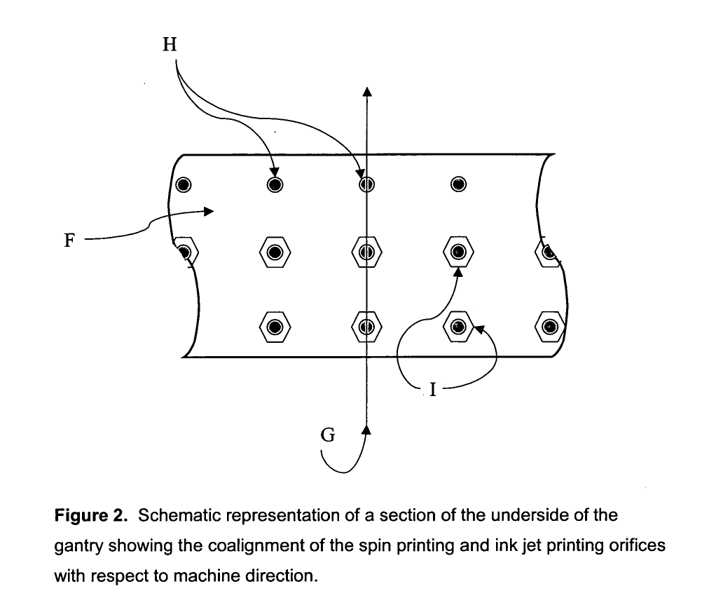

Mounted on the underside of the gantry are a series of spin jets and ink jets. If, for instance, the glass substrate is to be used for a video display and it is desired to print 1024 conductor lines across the glass substrate, and there is to be one gantry, then there will be 1024 spin jets mounted on that gantry. One possible arrangement is shown in FIG. 2. The view is the underside of the gantry (F) showing that it is perpendicular to the machine direction (G). The spin jets (H) and ink jets (I) are coaligned in the machine direction (G). Thus, as the glass substrate approaches, the initial contact pads would be printed by the ink jets (I). These pads are easily printed at 50 to 150 μm widths. The use of two heads would provide two passes to get sufficient thickness. The main conductor trace across the glass would be produced by the spin jets (H) starting on top of the connector pads and traversing the entire substrate. This trace is easily printed at 20 to 50 microns width. Approaching the far edge of the substrate, the ink jets would print the connector pads on the substrate just before the spin jets lay the main conductor trace across the pads.

If it is desired that the contact pads of the conductors be alternated on opposite sides of the substrate, then 512 alternating pairs of ink jets would be utilized on the leading edge of the substrate and the other 512 would be utilized on the trailing edge.

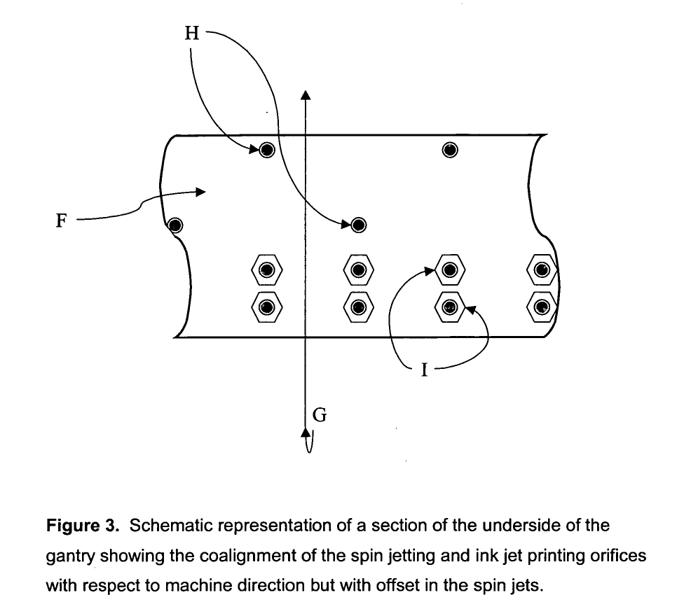

An alternative arrangement of jets is shown in FIG. 3. The view is the underside of the gantry (F) showing that it is perpendicular to the machine direction (G). The spin jets (H) and ink jets (I) are still co-aligned in the machine direction (G). However, the spacing of the main conductor lines may be too close together to allow for the die swell coming out of the spin jets. Or there may be other physical considerations that require a greater spacing of the spin jets. In that case, the spin jets (H) can be staggered as shown or otherwise offset to provide the required separation while maintaining the close spacing relative to the machine direction.

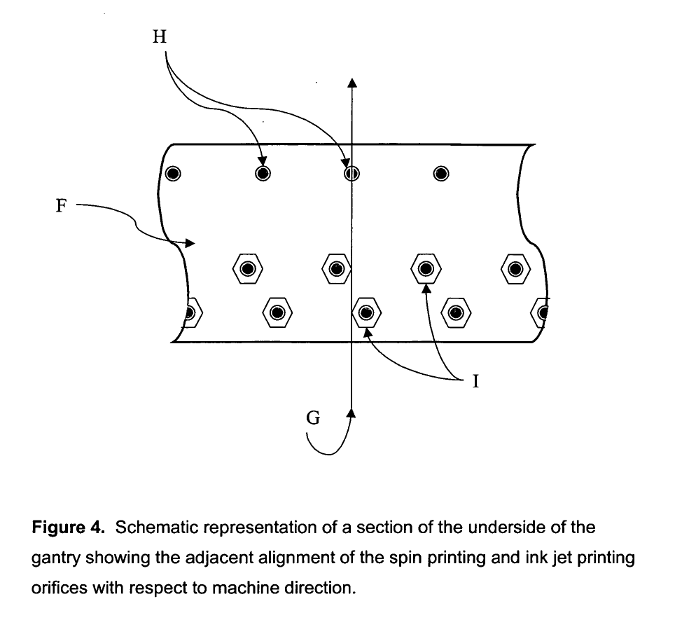

Another alternative arrangement of jets is shown in FIG. 4. The view is the underside of the gantry (F) showing that it is perpendicular to the machine direction (G). The spin jets (H) are coaligned perpendicular to the machine direction (G) but not aligned with the ink jets (I). Rather, the ink jets (I) are offset relative to spin jets (H) in the machine direction (G). This type of configuration would be preferred when larger contact pads are desired. Thus if the particular ink jets provide single-drop lines of 150 μm, the resulting contact pads could be as wide as 200-300 μm wide allowing for some overlap with the main conductor line during the printing process.

For more complex patterns, additional gantries can be added. For instance, the even numbered lines could be printed from one gantry and the odd numbered lines could be printed from the other. If multiple passes of either the spin jets or the ink jets are required, this could be accomplished from one or more additional gantries.

In the printing of glass panels for displays, a high degree of precision is required. Thus the transport mechanism for conveying glass substrates under the gantry would have to be capable of exacting tolerances. The spin printing process is inherently more precise than ink jetting, so this precision would be brought to the long conductor traces. The tolerances of the contact pads are less demanding and ink jetting brings its greater flexibility to these aspects of the printing process.

While advantageous, it is not required that the spin jets and ink jets be mounted on the same gantry or that the two processes be carried out together. In fact, there is no requirement that the two processes be carried out on the same piece of equipment. However, there are significant advantages to doing so. First, there are no issues of re-registration of the substrate between the first and second step. The second is that clean room space is at a premium; carrying out the entire process in a single piece of equipment would minimize the space required by eliminating one of two equal sized pieces of equipment and the substantial materials-handling equipment between the two.

There are a wide variety of ink jetting devices available today. Thermal jet, bubble jet and piezoelectric are a few of the broad descriptors in combination with continuous or drop-on-demand. While any of these and others can be applied to the processes disclosed herein, it is generally preferred to utilize a piezoelectric ink jet head. Drop-on-demand is highly preferred. The reliability of the inks is critical despite the required heavy loadings of conductor or other active phase because it may be desirable to print only occasionally while the spin jets will generally be printing continuously.

The spin printing formulations described herein contain a relatively dilute, extensible solution of an ultrahigh molecular weight polymer. A low solution concentration of the ultrahigh molecular weight polymer in the dispersing vehicle is essential to the composition of the process disclosed herein. In some embodiments, the formulation also contains a material that can become a functional phase in an electronics or display application. Finally, the formulation can contain a variety of other materials that aid in the formulation of the composition, the printing of the composition, or the performance of the composition in the end use application. Lines of the functional phase are printed onto a substrate by a spin printing process, which includes forcing the formulation through an orifice to form a continuous filament that may or may not be stretched before being laid down onto the substrate surface. The dispersing vehicle is evaporated to form the line and the other components may or may not be burned out of the line.

Virtually any system in which a linear, ultrahigh molecular weight polymer is soluble in a solvent will work, though some are more practical than others. The ultrahigh molecular weight polymer in solution imparts significant viscoelasticity to the solution, making the solution extensible even at very low concentrations of the polymer. Similar effects can be seen for more concentrated solutions of polymers that are merely high but not ultrahigh molecular weight, but the high concentrations required put additional demands upon the system. In a polymeric fluid, which is viscoelastic, there are normal (elastic) forces generated during shear in addition to the viscous forces. Since normal-forces scale with weight average molecular weight (Mw) to the 7th power, versus viscous forces that scale to Mw to the 3.4 power, as the molecular weight of the polymer builds, the normal forces scale very quickly.

The term “ultrahigh molecular weight polymer”, as used herein, generally refers to a linear polymer having a molecular weight over 1,000,000. The term includes single homopolymers and copolymers and mixtures of homopolymers and/or copolymers. Useful polymers for aqueous solutions include, but are not limited to poly (ethylene oxide), poly(acrylamide), xanthans and guar gum. Materials that are especially suitable for spin printing in an aqueous system are typically viscoelastic polymers having the following characteristics: a high polarity, water solubility, high molecular weight and a high hydrogen bond forming capability. Also, significantly, they are very long or ultrahigh molecular weight, having a high linearity with few side branches and a large length to diameter ratio. Solubility and high molecular weight are also important for effective dissolution of the ultrahigh molecular weight polymer in the water to achieve the desired properties. Some materials that work well are guar gum, locust bean gum, carrageenan (“Irish moss”), gum karaya, hydroxyethyl cellulose, sodium carboxymethylcellulose, DAPS 10 [acrylamide-3-(2-acrylamido-2-methylpropyl)dimethylammonio)-1-propanesulfonate copolymer], polyethylene oxide, polyacryamide and polyvinylpyrrolidone. These materials are exemplary of substances exhibiting the above characteristics and thus work well in spin printing. Poly(ethylene oxide) and poly(acrylamide) are preferred polymers, and poly(ethylene oxide) is especially preferred. Included in the term poly(ethylene oxide) are both homo- and copolymers of ethylene oxide. Similarly, the term poly(acrylamide) is meant to include homopolymers of acrylamide as well as its copolymers with monomers such as acrylic acid or N-alkylacrylamides.

The concentration by weight of the polymer in the formulated composition is about 0.1-8%, preferably about 0.5-5%, and more preferably about 1-2%. The optimum concentration will depend on many factors such as the molecular weight of the polymer being used and its chemical structure. Generally speaking, the higher the molecular weight of the polymer, the lower the concentration that will be needed in the extensible viscoelastic solution. Some polymers for the extensible solutions, particularly natural polymers, may have some fraction that is insoluble in water. This insoluble fraction should preferably be removed, as by filtration of the solution, preferably avoiding reduction of the molecular weight of the polymer in solution.

Useful polymers for hydrocarbon solutions include, but are not limited to poly(alpha-olefins) where the olefins contain eight or more carbon atoms. For instance, polyoctene, polydecene, polydodecene, polytetradecene, polyhexadecene, polyoctadecene, polyeicosene, and higher, and copolymers of mixed alpha-olefins such as polyhexene/codecene, polypentene/cohexadecene, polyhexene/cooctenne/codecene, and related copolymers, have been produced using traditional Ziegler Natta catalysts. These polymers dissolved in hexane, octane, methylcyclohexane, decane, decaline, petroleum ethers, purified kerosenes, Exxon's Isopar® high purity isoparafinic solvents, or other hydrocarbon solvents are suitable non-aqueous systems for spin printing. They can be quite effective in use, but in practical terms, may suffer from the flammability of the solvent.

The term “dispersing vehicle”, as used herein, refers to fluids that are solvents or mixtures of solvents for the ultrahigh molecular weight polymer and will disperse the active component particles. Solvents can be pure chemicals or mixtures of chemicals. For instance, it can be useful to combine water with an alcohol or glycol to modify the rate of evaporation of the overall solvent mixture. Similarly, butyl acetate solvent can be used in conjunction with 2,2,4-trimethyl-1,3-pentanediol monoisobutyrate to modify the rate of evaporation.

The term “functional phase particles” as used herein refers to materials that impart conductive, resistive, emissive, phosphorescent, barrier, insulator, or dielectric properties to the composition. The “functional phase particles” can also impart UV or visible absorption to the composition or can act as photoactive species such as photocatalysts. It is generally desired that the functional phase particles contained herein are spherical or close to spherical in shape, but in contrast to ink-jet printing systems, acicular materials can be accommodated. Components of the composition are described herein below. The term “functional phase particles” as used herein does not refer to materials designed to impart improved strength or stability to the ultrahigh molecular weight fraction of the composition.

The concentration by weight of the functional phase particles in the formulated composition is about 0.1-70%, preferably about 0.5-50%, and more preferably about 1-30%. The optimum concentration will depend on many factors that include the density of the functional phase, the ability to disperse the material in the overall composition, the dimensions of the resulting desired images. The ability to disperse the material is dependent upon a variety of factors including the particle size of the material, the surface energy of the material, any surface treatments of the material, and the efficacy of energy input in the dispersion process, to name a few.

In conductor applications, the functional phase is comprised of electrically functional conductor powder(s). The electrically functional powders in a given composition can comprise a single type of powder, mixtures of powders, alloys or compounds of several elements. Examples of such powders include: gold, silver, copper, nickel, aluminum, platinum, palladium, molybdenum, tungsten, tantalum, tin, indium, lanthanum, gadolinium, ruthenium, cobalt, titanium, yttrium, europium, gallium, zinc, silicon, magnesium, barium, cerium, strontium, lead, antimony, conductive carbon, and combinations thereof and others common in the art of thick film compositions. In systems to be fired at elevated temperatures, silver oxide can be employed because it auto-reduces to silver metal under firing conditions.

The term “functional phase particles” also includes “precursor compositions” or materials that can be formed in situ from “precursor compositions.” Such an approach is disclosed in the international application, WO 03/032084, incorporated herein by reference in its entirety. The precursor compositions preferably have chemical reactivity that allows them to be decomposed, reduced, oxidized, hydrolyzed or is otherwise converted into “functional phase” under relatively mild conditions. For instance, conductive functional phases could be formed by the low temperature decomposition of organometallic precursors, thereby enabling the formation of electronic feature on a variety of substrates, including organic substrates. The precursor compositions to conductive systems can include various combinations of molecular metal precursors, solvents, micron-sized particles, nanoparticles, vehicles, reducing agents and other additives. The precursor compositions can advantageously include one or more conversion reaction inducing agents adapted to reduce the conversion temperature of the precursor composition. The conductive precursor compositions can be deposited onto a substrate and reacted to form highly conductive electronic features having good electrical and mechanical properties. The conductive precursor compositions according to the present disclosure can be formulated to have a wide range of properties and a wide range of relative cost. For example, in high volume applications that do not require well-controlled properties, inexpensive conductive precursor compositions can be deposited on cellulose-based materials, such as paper, to form simple disposable circuits. Ceramic precursor compositions could be formulated in non-aqueous solvent systems from metal alkoxides that would undergo subsequent hydrolytic transformations upon exposure to water or atmospheric moisture.

The electrically functional powders described above are finely dispersed in an organic medium and are optionally accompanied by inorganic binders. The term “inorganic binders” as used herein refers to materials that cause the functional phase materials to perform better in the end-use application. Inorganic binders frequently cause the functional material to bind more securely to the substrate. Alternatively, they can reduce the surface tension of the functional phase materials to improve continuity in the printed pattern. These can be metal oxides, ceramics, and fillers, such as other powders or solids. These materials can be identical in composition to some of the active components in other applications, but when used as a binder, they are generally present in lower concentrations in the overall composition. The function of an inorganic binder in a composition is binding the particles to one another and to the substrate after firing. Examples of inorganic binders include glass binders (frits), metal oxides and ceramics. Glass binders useful in the composition are conventional in the art. Some examples include borosilicate and aluminosilicate glasses. Examples further include combinations of oxides, such as: B₂O₃, SiO₂, Al₂O₃, CdO, CaO, BaO, ZnO, SiO₂, Na₂O, Li₂O, PbO, and ZrO which can be used independently or in combination to form glass binders. Typical metal oxides useful in thick film compositions are conventional in the art and can be, for example, ZnO, MgO, CoO, NiO, FeO, MnO and mixtures thereof.

The glass frits most preferably used are the borosilicate frits, such as lead borosilicate frit, bismuth, cadmium, barium, calcium, or other alkaline earth borosilicate frits. The preparation of such glass frits is well known and consists, for example, of melting together the constituents of the glass in the form of the oxides of the constituents and pouring such molten composition into water to form the frit. The batch ingredients can be any compounds that will yield the desired oxides under the usual conditions of frit production. For example, boric oxide will be obtained from boric acid, silicon dioxide will be produced from flint, barium oxide will be produced from barium carbonate, etc. The glass is preferably milled in a ball mill with water to reduce the particle size of the frit and to obtain a frit of substantially uniform size. It is then settled in water to separate fines and the supernatant fluid containing the fines is removed. Other methods of classification can be used as well.

It is preferred that at least 85% the inorganic binder particles be in the range of 0.1-10 μm and more preferably in the range of 0.2-2 μm. The reason for this is that smaller particles having a high surface area tend to adsorb the organic materials and thus impede clean decomposition. On the other hand, larger size particles tend to have poorer sintering characteristics. It is preferred that the weight ratio of inorganic binder to total solids be in the range 0.02 to 5 and more preferably in the range 0.1 to 2 and all ranges contained therein.

The binder materials may or may not be present in the formulations of other active components in compositions for resistive, emissive, phosphorescent, barrier, insulator, or dielectric applications.

Some or all of the solid-state inorganic binder or frit can be replaced with metal resinates and as used herein, the term inorganic binders is meant to include metal resinates. As used herein, the term “metal resinate” refers to organic metallic compounds which upon firing will be converted to inorganic oxides or glasses playing a role similar to the glass frit inorganic binders. The resinates are soluble or dispersible in the solvent used in the spin printing system. Common metallic soaps available on the market can be used as organic acid salts of base metals. Metals available for organic acid salts include such precious metals as Au, Ag, Pt, Rh, Ru and Pd. Available organic acid salts of base metals include Na, Mg, Al, Si, K, Ca, Ti, V, Cr, Mn, Fe, Co, Ni, Cu, Zn, Sr, Zr, Nb, MO, Cd, In, Sn, Sb, Cs, Ba, Ta, Pb and Bi. An appropriate material can be selected from the foregoing materials according to the properties required of the conductive paste. Another type of metal resinate is a chelate-type compound such as an organotitanate. Metal resinates can range from highly fluid to very viscous liquids and to solids as well. From the standpoint of use in the disclosure, the solubility or dispersability of the resinates in the medium is of primary importance. Typically, metal resinates are soluble in organic solvents, particularly polar solvents such as toluene, methylene chloride, benzyl acetate, and the like.

The “functional phase particles” are preferably nanoparticles with the maximum size of the particles required for ink jetting being smaller than those required for the spin printing. Nanoparticles to be ink jetted have an average size of not greater than about 100 nanometers, such as from about 10 to 80 nanometers. Particularly preferred for compositions are nanoparticles having an average size in the range of from about 25 to 75 nanometers though for spin printing, they can be up to a micron in diameter.

Nanoparticles that are particularly preferred for use in the present disclosure are not substantially agglomerated. Preferred nanoparticle compositions include Al₂O₃, CuO_{X}, SiO₂ and TiO₂, conductive metal oxides such as In₂O₃, indium-tin oxide (ITO) and antimony-tin oxide (ATO), silver, palladium, copper, gold, platinum and nickel. Other useful nanoparticles of metal oxides include pyrogenous silica such as HS-5®) or M5 or others (Cabot Corp., Boston, Mass.) and AEROSIL-200® or others (Degussa AG, Dusseldorf, Germany) or surface modified silica such as TS530® or TS720® (Cabot Corp., Boston, Mass.) and AEROSIL-380® (Degussa AG, Dusseldorf, Germany). In one embodiment of the process disclosed herein, the nanoparticles are composed of the same metal that is contained in the metal precursor compound, discussed below. Nanoparticles can be fabricated using a number of methods and one preferred method, referred to as the Polyol process, is disclosed in U.S. Pat. No. 4,539,041 by Figlarz et al., which is incorporated herein by reference in its entirety.

The “functional phase particles” for spin printing according to the technology disclosed herein can also include micron-size particles, having an average size of at least about 0.1 μm. Preferred compositions of micron-size particles are similar to the compositions described above with respect to nanoparticles. The particles are preferably spherical, such as those produced by spray pyrolysis. Particles in the form of flakes increase the viscosity of the precursor composition and are not amenable to deposition using tools having a restricted orifice size, such as an ink-jet device. When substantially spherical particles are described herein, the particle size refers to the particle diameter. In one preferred embodiment, the low viscosity precursor compositions according to the present disclosure do not include any particles in the form of flakes.

It is known that micron-size particles and nanoparticles often form soft agglomerates as a result of their relatively high surface energies, as compared to larger particles. It is also known that such soft agglomerates can be dispersed easily by treatments such as exposure to ultrasound in a liquid medium, sieving, high shear mixing and 3-roll milling.

As used herein, the term “dispersing vehicle” is a fluid for spin printing or ink jet printing whose main purpose is to serve as a vehicle for the dispersion of the finely divided solids of the active component of the composition in such form that it can readily be applied to a ceramic, glass or other substrate. The solvent components of the dispersing vehicle should be inert (non-reactive) towards the other components of the composition. For spin printing the dispersing vehicle must also be a solvent for the ultrahigh molecular weight polymer while for ink jet systems, they must be of low viscosity. Thus, the dispersing vehicle must first be one in which the solids are dispersible with an adequate degree of stability. Secondly, the rheological properties of the organic medium must be such that they lend good application properties to the dispersion.

The solvent(s) should have sufficiently high volatility to enable the solvent to be evaporated from the dispersion by the application of relatively low levels of heat at atmospheric pressure; however, the solvent should not be so volatile that the ink rapidly dries at normal room temperatures, during the spin-printing or ink-jetting processes. The preferred solvents for use in the compositions should have boiling points at atmospheric pressure of less than 300° C. and preferably less than 250° C. For more polar polymer systems, such solvents include water, aliphatic alcohols, esters of such alcohols, for example, acetates and propionates; terpenes such as pine oil and alpha- or beta-terpineol, or mixtures thereof; ethylene glycol and esters thereof, such as ethylene glycol monobutyl ether and butyl cellosolve acetate; carbitol esters, such as butyl carbitol, butyl carbitol acetate and carbitol acetate and other appropriate solvents such as TEXANOL-B®) (2,2,4-trimethyl-,3-pentanediol monoisobutyrate).

For non-polar polymer systems such as poly(alpha-olefins), the solvents will be non-polar systems such as alkanes; examples of useful systems include hexane, cyclohexane, methylcyclohecanes, octane, decane, Isopar®) alkanes, petroleum ethers, purified kerosenes, terpenes and long-chain alkylethers. Aromatic solvents generally do not work well with poly(alpha-olefins) unless high operating temperatures are employed or there is some aromatic content in the polymer (See, for instance, U.S. Pat. No. 6,576,732). Solvents for crystalline polymer such as poly(ethylene terephthalate) or nylons will be highly polar hydrogen bonding solvents such as hexafluoroisopropanol, phenol, catechols, or formic acid.

As discussed above, the primary solvents used in the spin printing systems must be chosen in tandem with the ultrahigh molecular weight polymer. Water is the most common vehicle employed in these systems because it is compatible with many of the polymers and it is non-flammable as opposed to the solvents for the polyolefin systems. Water is commonly used in combination with a variety of hydrophilic organic molecules to modify the rate of evaporation, the wetting of the substrate, the compatibility with other additives and water as used herein is meant to imply systems in which the major component of the dispersing vehicle is water.

The ability to utilize mixtures of solvents in the processes disclosed herein provides considerable process advantages through operating latitude, particularly for the ink jetting process. Multiple solvents chosen to have specific evaporation or volatilization profiles can be critical in the development of uniform lines and edges, and in assuring adhesion of the printing ink to the substrate surface. In a preferred process, the primary solvent for both inkjetting and spin printing is water used in combination with other organic solvents having varied volatilities.

The vapor pressure of the organic molecules present in the dispersing vehicle should be sufficiently low that it does not rapidly evaporate from the paste at room temperature. This is to avoid reducing the “working life” of the ink. Additionally, if the vapor pressure is too high, it may vaporize during heat treatment too rapidly, which can produce an image containing excessive voids. The vapor pressure should be high enough to completely vaporize from the paste within a commercially practical time during heat treatment. The vapor pressure will therefore, at least in part, depend on the conditions of heat treatment.

As used herein, the term “adjuvants” refers to a variety of additives whose purpose is to improve the performance of the process or system. For instance, polymeric dispersants and binders are generally used in the compositions. For spin printing, the concentrations can be equal to or higher than those of the ultrahigh molecular weight polymers. As a result of their low molecular weight, in general, the adjuvants contribute little to the viscoelastic properties of the system. They play a different role in that they help in the dispersion of the inorganic phases in the medium and help maintain the suspensions once dispersion is achieved, and are thus selected to be compatible with the dispersing vehicle being employed and generally have a high affinity for or solubility in the dispersing vehicle.

Water-based pigment dispersions are well known in the art, and have been used commercially for applying films such as paints or inks to various substrates. The pigment dispersion is generally stabilized by either a non-ionic or ionic technique. When using the non-ionic technique, the pigment particles are stabilized by a polymer that has a water-soluble, hydrophilic section that extends into the water and provides entropic or steric stabilization. Representative polymers useful for this purpose include polyvinyl alcohol, cellulosics, ethylene oxide modified phenols, and ethylene oxide/propylene oxide polymers. In aqueous systems, homopolymers, random copolymers and block copolymers of vinylpyrrolidone are particularly useful. The non-ionic technique is not sensitive to pH changes or ionic contamination. In many applications, it has a major disadvantage in that the final product is water sensitive. Thus, if used in ink applications or the like, the pigment will tend to smear upon exposure to moisture. In many of the applications involving the printing of ultra-fine active components discussed herein, this water sensitivity is not an issue in that the organic components will be removed by firing leaving the ultrafine active component behind.

In the ionic technique, the pigments or ultrafine particles are stabilized by a polymer of an ion containing monomer, such as neutralized acrylic, maleic, or vinyl sulfonic acid. The polymer provides stabilization through a charged double layer mechanism whereby ionic repulsion hinders the particles from flocculating. Since the neutralizing component tends to evaporate after application, the polymer then has reduced water solubility and the final product is not water sensitive. Unfortunately, in most cases the ionic stabilizers will leave behind an inorganic residue of the counterion upon firing. In the case of ammonium, phosphonium or related ionic stabilizers, this residue can be mitigated. In certain circumstances, the counterions can even serve the role of inorganic binder. Thus it is a complex combination of variables that will influence the choice of dispersants.

The polymeric dispersants can also be binders after the solvent has evaporated, but binders can also be required, independently. There are two general classes of polymer binder that are commercially available polymers. They can be used independently or together in the formulations. First are binders made of copolymer, interpolymer or mixtures thereof made from (1) nonacidic comonomers comprising C₊₁₀ alkyl methacrylate, C₁₋₁₀ alkyl acrylates, styrene, substituted styrene, or combinations thereof and (2) acidic comonomer comprising ethylenically unsaturated carboxylic acid containing moiety; the copolymer, interpolymer or mixture thereof having an acid content of at least 10 weight % of the total polymer weight; and having an average glass transition temperature (Tg) of 50-150° C. and weight average molecular weight in the range of 2,000-100,000 and all ranges contained therein.

The polymers formulated into the compositions for the technology disclosed herein function to impart significant viscoelasticity for spinning and to suspend the other ingredients in the solvent so that they can be conveniently spun and applied to the substrate. Furthermore, the solvent diffuses from the paste and vaporizes during heat treatment to provide a substantially liquid-free, active component in combination with the polymeric components.

Both the ultrahigh molecular weight polymers and the adjuvant polymers act as “fugitive polymers” in most applications. It is important that the polymeric components are eliminated during firing or heat treatment in such a way as to provide a final image that is substantially free of voids and defects. The polymers “fugitive polymers” undergo 98-100% burnout under the firing conditions. The polymer is referred to as a “fugitive polymer” because the polymer material can be burned out of the functional components at elevated temperatures prior to fusing or sintering of the functional components on the substrate. As opposed to the solvent components that are simply volatilized, the polymeric components generally undergo thermal decomposition or oxidation to be removed. Thus, an important factor in the choice of both the ultrahigh molecular weight components and the dispersant component is their thermal behavior as indicated by thermogravimetric analysis. In general, it is desired that the polymers leave behind no carbonaceous residue, thus aromatic polymer systems are generally not preferred. For example, binder materials containing a significant proportion of aromatic hydrocarbons, such as phenolic resin materials, can leave graphitic carbon particles during firing which can require significantly higher temperatures for complete removal. It is also desirable that the polymeric components do not melt or otherwise become fluid during the firing process so that there is no degradation of the printed image.

As used herein, the term “deposit composition” refers to the composition that has been or is about to be deposited on the surface of a substrate.

Additional components known to those skilled in the art can be present in the compositions; they include dispersants, stabilizers, release, agents, dispersing agents, stripping agents, and antifoaming agents. A general disclosure of suitable materials is presented in U.S. Pat. No. 5,049,480.

The techniques disclosed herein can be applied to a wide variety of substrates. The types of substrates that are particularly useful include polyfluorinated compounds, polyimides, epoxies (including glass-filled epoxy), polycarbonates and many other polymers. Particularly useful substrates include cellulose-based materials such as wood or paper, acetate, polyester, polyethylene, polypropylene, polyvinyl chloride, acrylonitrile, butadiene (ABS), flexible fiber board, non-woven polymeric fabric, cloth, metallic foil, ceramics and glass. The substrate can be coated—for example a dielectric on a metallic foil or a metal on a ceramic or glass.

One difficulty in printing fine features is that the printed composition can wet the surface and rapidly spread to increase the width of the deposit, thereby negating the advantages of fine line printing. This is particularly true when printing is employed to deposit fine features such as interconnects or conductors for displays.

Spreading of the precursor composition is influenced by a number of factors. A drop of liquid placed onto a surface will either spread or not depending on the surface tensions of the liquid, the surface tension of the solid and the interfacial tension between the solid and the liquid. If the contact angle is greater than 90°, the liquid is considered non-wetting and the liquid tends to bead or shrink away from the surface. For contact angles less than 90°, the liquid can spread on the surface. For the liquid to completely wet, the contact angle must be zero. For spreading to occur, the surface tension of the liquid must be lower than the surface tension of the solid on which it resides.

The compositions can be confined on the substrate thereby enabling the formation of features having a small minimum feature size, the minimum feature size being the smallest dimension in the x-y axis, such as the width of a conductive line. The composition can be confined to regions having a width of not greater than 100 μm, preferably not greater than 75 μm, more preferably not greater than 50 μm, and even more preferably not greater than 25 μm. The technology disclosed herein provides an apparatus and methods of processing that advantageously reduce the spreading of the composition. For example, small amounts of rheology modifiers such as styrene allyl alcohol (SAA) and other polymers can be added to the precursor composition to reduce spreading. The spreading can also be controlled through combinations of nanoparticles and precursors. Spreading can also be controlled by rapidly drying the compositions during printing by irradiating the composition during deposition.

A preferred method is to pattern an otherwise wetting substrate with non-wetting enhancement agents that control the spreading. For example, this can be achieved by functionalizing the substrate surface with trialkylsilyl, hydrocarbyl or fluorocarbon groups.

Fabrication of conductor features with feature widths of not greater than 100 μm or features with minimum feature size of not greater than 100 μm from a composition requires the confinement of the low viscosity precursor compositions so that the composition does not spread over certain defined boundaries. Various methods can be used to confine the composition on a surface, including surface energy patterning by increasing or decreasing the hydrophobicity (surface energy) of the surface in selected regions corresponding to where it is desired to confine the precursor or eliminate the precursor. These can be classified as physical barriers, electrostatic and magnetic barriers, surface energy differences, and process related methods such as increasing the composition viscosity to reduce spreading, for example by freezing or drying the composition very rapidly once it strikes the surface.

A preferred method is to simultaneously print two immiscible compositions, one containing functional phase particles and the other without functional phase particles side by side on a substrate in such a manner that the composition without functional phase particles constrains the composition with functional phase particles to a specific surface area. The miscibility of the two compositions would be dictated largely by the dispersing vehicle. It is generally found that for ultrahigh molecular weight polymers, the solvent for a given polymer is limited, so it is likely that both the dispersing vehicle and the ultrahigh molecular weight polymer would be different to achieve immiscibility. Alternatively, the two compositions can both contain functional phase particles that are different. Such a procedure would result in one functional phase material being bound in position by the adjacency of the other.

A preferred method which is a variation of the immiscible composition approach is to print two miscible but differing compositions, one containing functional phase particles and the other without functional phase particles side by side on a substrate in such a manner that the composition without functional phase particles constrains the composition with functional phase particles to a specific surface area. The two dispersing vehicles in the two compositions my simply be miscible or they can be the same. While the miscibility of the two compositions would allow some mixing, the high solution viscosity of the ultrahigh molecular weight polymer causes the mixing or interpenetration of the two compositions to be minimal. As a result, diffusion of the functional phase particles is minimal. Alternatively, the two compositions can both contain functional phase particles that are different. Such a procedure would result in one functional phase material being bound in position by the other.

One embodiment provides a set of printing compositions designed to minimize the spreading of lines. The composition set comprises at least two compositions. The two dispersing vehicles and their respective ultrahigh molecular weight polymers can be chosen to be immiscible, thereby providing the maximum resistance to line spreading. Alternatively, the dispersing media can be miscible or can be the same, relying upon the high solution viscosity of the ultrahigh molecular weight polymer to minimize interpenetration of the two compositions.

Another example of a method for depositing the composition is to heat the composition relative to the temperature of the substrate to decrease the viscosity of the composition during printing. This can also have the advantage of volatilizing a portion of the dispersing vehicle before the composition reaches the substrate, thereby minimizing spreading of the line due to wetting of the surface.

Another example of a method for depositing the composition is using a heated substrate to increase the rate of volatilization of the dispersing vehicle. If the composition contains reactive species, the heated surface can cause the immediate reaction, thereby crosslinking or otherwise modifying the printed pattern.

Another example of a method for depositing the composition is using a chilled substrate to quickly increase the viscosity of the printed pattern to minimize spreading of the lines.

Another example of a method for depositing the composition is to employ an array of a plurality of spin jets. Thus, for example, to print 1000 parallel conductive silver lines on glass for a display, a spinning head containing 1000 spin jets would be used. Consecutive sheets of glass would be transported continuously beneath the spinning head to print all 1000 lines on each glass panel with no break in the silver-containing filament. Alternatively, a single head could be transported repeatedly back and forth across a single sheet of glass printing all 1000 lines. To print the contact pads, an ink jet orifice could be positioned to be precisely aligned with each spin jet. That ink jet head would then overprint the spin printed line with additional ink utilizing a droplet size that would make the contact pad substantially wider than the conductor line. Alternatively, two ink jet orifices could be positioned to be a precise distance on either side of each spin jet with respect to the machine direction. Those ink jet heads would then overprint the spin printed line with additional ink utilizing a droplet size that would make the contact pad substantially wider than the conductor line. Finally in another configuration representing an extreme, there would be a sufficient number of ink jet heads that they could print a continuous line across the substrate in a direction perpendicular to the machine direction. If fired simultaneously, the ink jet heads print a line perpendicular to the machine direction and if fired sequentially, the would print diagonals on the substrate. Firing randomly, they would produce no discernable pattern, contribute little to the overall absorption of the image and yet connect the parallel lines in random positions—a featureuseful in radio frequency shielding applications on display devices.

The conductive feature can be post-treated after deposition and conversion of the metal precursor. For example, the crystallinity of the phases present can be increased, such as by laser processing. The post-treatment can also include cleaning and/or encapsulation of the electronic features, or other modifications.

Another method for depositing the composition is using multi-pass deposition to build the thickness of the deposit. In one embodiment, the average thickness of the deposited feature is greater than about 0.1 μm and even more preferably is greater than about 0.5 μm. The thickness can even be greater than about 1 μm, such as greater than about 5 μm. These thicknesses can be obtained by deposition of discrete units of material by depositing more than a single layer. A single layer can be deposited and dried, followed by repetitions of this cycle. Sequential layers of material do not have to be taken through sequential drying processes; additional depositions can be carried out before the previous layer is completely dry. The use of multiple layers can be employed to build up substantial channels or vias on the surface of a substrate to physically confine the composition.

Channels on the surface of a substrate can be filled via the methods of this disclosure. The channels being filled can have been created by any of a number of processes. In this physical barrier approach, a confining structure is formed that keeps the composition from spreading. These confining structures can be trenches and cavities of various shapes and depths below a flat or curved surface that confine the flow of the precursor composition. Such trenches can be formed by chemical etching or by photochemical means. The physical structure confining the precursor can also be formed by mechanical means including embossing a pattern into a softened surface or means of mechanical milling, grinding or scratching features. Trenches can also be formed thermally, for example by locally melting a low melting point coating such as a wax coating. Alternatively, retaining barriers and patches can be deposited to confine the flow of composition within a certain region. For example, a photoresist layer can be spin coated on a polymer substrate. Photolithography can be used to form trenches and other patterns in this photoresist layer. These patterns can be used to retain precursor that is deposited onto these preformed patterns. After drying, the photolithographic mask may or may not be removed with the appropriate solvents without removing the deposited metal. Retaining barriers can also be deposited with direct write deposition approaches such as ink-jet printing or any other direct writing approach as disclosed herein.

The width of line features is a function of the concentration of the dispersing vehicle at the moment of contact with the substrate surface. Thus, if there is evaporation of the dispersing vehicle from the filament between the time that it exits the spin jet and the time that it contacts the surface of the substrate, wetting of the surface and spreading of the line will reduced. This is particularly true as the diameter if the drawn filament is reduced, thereby increasing the relative surface area of the filament from which evaporation can occur. On the rapid time frame of the imaging process, evaporation will occur primarily from the surface of the filament rather than uniformly throughout. This further contributes to minimization of spreading on the substrate surface.

It will be appreciated from the foregoing discussion that two or more of the latter process steps (drying, heating, reacting and sintering) can be combined into a single process step.

When forcing the composition through the spin jet, a variety of methods can be employed. A positive displacement pump can be employed to maintain a constant flow rate. Syringe pumps are typically employed for this approach. Alternatively, the composition can be maintained at a constant positive pressure sufficient to force it through the spin jet at the desired rate.

The substrates for this process can be rigid or flexible. Generally, it is desired that the substrates not be highly absorbant and the surface of the substrate must be clean, free from defects, and smooth.

Rigid substrates would encompass for example, glass, rigid crystalline or amorphous plastics, glass with various surface treatments, or various electrical components previously printed onto a rigid substrate. Rigid substrates are useful in display devices such as plasma display panels, or liquid crystal displays. Substrates such as crystalline and amorphous silicon for solar energy devices can be printed using the techniques reported herein.

Flexible or semiflexible substrates are useful in a number of manners. The substrates can include flexible plastics such as Mylar® poly(ethylene terephthalate), or other polyester films, Kapton® polyimide films, paper, surface-coated paper, polyethylene, polypropylene and biaxially-oriented polypropylene, or other natural and synthetic polymer systems. The printed flexible substrates can be incorporated into the final device. Alternatively, the image printed on the flexible substrate can be transferred onto the final device. Generally, patterns spin-printed onto flexible substrates cannot be fired at high temperatures due to the stability of the flexible substrate, but after transfer to or lamination on to rigid substrates, the system can be fired to achieve the final desired properties and to remove the flexible portion of the system.

Care was taken to avoid dirt contamination in the process of preparing paste compositions and in preparing parts, since such contamination can lead to defects. The parts were dried at 80° C. in an air atmosphere oven. The dried parts were then normally fired in an air atmosphere at peak temperatures of 500° C. or under.

The compositions of the present disclosure can be processed by using a firing profile. Firing profiles are well within the knowledge of those skilled in the art of thick film technology. Removal of the organic medium and sintering of the inorganic materials is dependent on the firing profile. The profile will determine if the medium is substantially removed from the finished article and if the inorganic materials are substantially sintered in the finished article. The term “substantially” as used herein means at least 95% removal of the medium and sintering the inorganic materials to a point to provide at least adequate resistivity or conductivity or dielectric properties for the intended use or application.

When the image is being made onto a flexible medium for subsequent lamination, the spin-printed image can be protected by lamination with a coversheet before it is wound as a widestock roll. Silicone coated terephthalate PET film, polypropylene, or polyethylene can be used as a coversheet. The coversheet is removed before laminating to the final substrate.

Spin-printing is accomplished by spinning the viscoelastic polymer solution containing the functional phase and other components through a die or spin jet onto a substrate that is in motion relative to the spin jet. The solution-spun filament is made by forcing the organic solvent containing the polymer and other ingredients through the orifice of the die. The orifice of the die will typically be round, but can also be of other desired geometries. Dies have orifices of varied shape can be utilized to produce filaments having a wide variety of cross sectional designs, for example, round, square, rectangular, or elliptical. For instance, a die having a rectangular orifice can be utilized to produce a filament that is essentially in the form of a ribbon or film. If the shape of the filament is other than round, the orientation of the die shape relative to the substrate can be adjusted as desired. For instance, a ribbon or rectangular shape can be placed on the substrate either vertically or horizontally, as desired. It is generally convenient to utilize a die having an orifice that is essentially circular. The orifice of such dies will typically have a diameter that is within the range of about 20 to about 400 microns. In most cases, it is preferred for such orifices to have a diameter that is within the range of about 30 microns to about 200 microns.

Spinnerets that are equipped with multiple orifices can be used to print multiple lines in a single pass. Spacing of the multiple holes can be regular to provide a regular array of lines or spaced in a particular pattern to give a particularly desired array of lines. Dies with multiple holes do not necessarily need to be placed perpendicularly to the direction being printed. A diagonal placement will allow lines to be printed with spacing more narrow than the spacing of holes in the die. Holes in the die which are aligned parallel to the printing direction would allow multiple thicknesses to be printed in a single pass or to have two or more different compositions printed one atop another in a single pass.

The polymer solution containing the functional phase and other ingredients is forced through the die at a rate that is sufficient to attain a spinning speed of about 1 meter per minute to about 1000 meters per minute. Typically, the spinning speed is between about 2 meters per minute to about 400 meters per minute. It is generally desirable to utilize the fastest possible spinning speed that retains satisfactory uniformity.

However, it may also be convenient to utilize slower spin-printing speeds to match the speed of the printing process with the speed of subsequent, down-stream steps in the manufacturing process. Higher spinning speeds are also desirable because they result in higher throughputs and better productivity. For this reason, spinning speeds in excess of 400 meters per minute would be desirable if uniformity and other desired properties can be maintained. It is expected that the lower spin-printing speeds will be utilized on rigid substrates where the machine direction is not parallel to the spinning direction. A potential configuration where the filament is deposited on a flat glass substrate is shown in FIG. 1. Gas flow can be utilized to lay the polymer onto the substrate. Areas where no printing is desired can be masked during the continuous printing process.

Higher speed can be sustained when the printing and spinning directions are in alignment. This would be exemplified by spin-printing onto a flexible substrate where the surface of the substrate can be aligned with the direction of the spin jets. A second potential configuration where the filament is deposited on a moving flexible substrate is shown as FIG. 2. In these figures, it is noted that the printing head is fixed and the substrate is moving. While there are significant advantages to this approach, it is quite possible that the substrate can be fixed and the printing heads will move.

The polymer solution is forced through the die or spin jet utilizing an adequate pressure to attain the spinning speed desired. The temperature of the process must be below the boiling point of the solvent. The polymer solution will typically be spin-printed at a temperature that is within the range of about 20° C. to about 70° C. when the solvent is water. The temperature will be determined by engineering of the process, the chosen solvent, its rate of evaporation, spinning speeds and other process variables. Temperatures above room temperature and controlled humidity conditions (primarily but not exclusively for aqueous-based systems) are desirable so that a uniform evaporation is easily maintained as atmospheric condition change. It is preferred that much of the solvent is removed from the polymer solution after passage through the die. Judicious choice of organic solvents would allow greater variation of the operating temperatures for the process.

As the solution-spun filament exits the spin jet, it can be subjected to a drawing procedure. During the drawing procedure the solution spun filament is drawn to a total draw ratio of at least about 1:1 to 50:1. The total draw ratio will typically be within the range of about 5:1 to about 20:1 for circular filaments. It is advantageous to utilize drawing to decrease line size, increase uniformity and possibly orient acicular active components. Drawing of non-circular filament shapes will be minimal because there is a tendency of all shapes to approach circular upon drawing.

Multiple spin jets can be employed and multiple active components can be printed in a single pass. This would be particularly advantageous on a flexible substrate. The two components could be laid one atop the other or side by side. One potential configuration is shown in FIG. 3.

For instance, the components of barrier ribs for plasma display panels could be printed between rows of a fugitive polymer onto a flexible sheet. Shaped spinning is useful to establish the desired aspect ratio of rib height to width and the shape would be maintained by the fugitive polymer component. The two component system could be transferred to a glass substrates in registration and the fugitive polymer channels would assure that the barrier ribs would retain their shape during the transfer and firing processes.

If a phosphor or other active components were contained in the fugitive polymer component, the phosphor would line the resulting channels after the firing process eliminating multiple steps in the manufacturing process. Extrusion coating of a barrier or cover layer can be carried our subsequent to the printing step yet all in the same overall process. The resulting structure would be that shown in FIG. 4.

A process for creating an image on a substrate comprises three principal components, steps, each of which involves further steps. The principal components of the process are spin printing, inkjetting, and evaporating.

Spin printing (A) involves continuously forcing a deposit composition comprising between 20 and 80 percent by weight of functional phase particles, a dispersing vehicle, and between 0.1 and 8 percent by weight of an ultrahigh molecular weight polymer soluble in that dispersing vehicle through an orifice to form a filament. That filament is generally elongated though elongation is not required. The resulting filament is deposited onto the substrate to form a line.

Inkjetting (B) includes dropwise ejecting an ink composition comprising between 20 and 70 percent by weight of functional phase particles, a dispersing vehicle, and between 1 and 10 percent of dispersant polymer, and depositing those drops on the substrate connected to the line derived from the spin printing step.

Evaporating the dispersing vehicle from the deposited filament and droplets results in the functional phase particles being affixed to the substrate in the desired image.

A) and B) can be conducted in either order. A and B can be carried out or simultaneously, although it will be recognized by one skilled in the art that it may be impractical to carry them out simultaneously on the same location on the substrate. Optionally, the resulting substrate and deposited image can be heated to a temperature sufficient to effect removal of the organic components.

There are many additional potential aspects to the process. Other manifestations of the described process include the following. The functional phase materials in the inkjet ink and the spin printing ink can be the same. The functional phase materials in the inkjet ink and the spin printing ink can be of the same chemical composition, but of different physical form including size, surface treatment, or aspect ratio. The functional phase materials in the inkjet ink and the spin printing ink can be different. The dispersing vehicle can be water for both inks. The dispersing vehicles can be water. The dispersing vehicle can be the same for the spin printing and the ink jetting ink. The dispersing vehicle can be different for the spin printing and the ink jetting ink. The process wherein either or both of steps A) and B) can be repeated several times before conducting step C). The process wherein there are a plurality of spin jets and/or a plurality of ink jets. The process wherein the spin printed line can be less than 100 microns wide. The process wherein the spin printed line can be less than 50 microns wide. The process wherein the spin printed line can be less than 20 microns wide. The process wherein the spin printed line can be less than 10 microns wide. The process wherein the ink-jetted portion of the line can be a terminal contact pad or an interconnect between two of the spin-printed lines. The process wherein there can be one inkjet orifice per spin jet and the two are precisely aligned in the machine direction so that the inkjet will print additional material to thicken the spin-printed line. The process wherein there are one or more inkjet orifices per spin jet and they are precisely aligned in a manner offset from the spin jet with respect to the machine direction to widen the line in specific areas.

In some embodiments, components A), B) and C) one of the process can be carried out continuously, effectively forming a continuous process.

The weight fraction of the functional phase particles can be from 0.5 to 50 percent of the deposit composition, preferably from 1 to 30 percent by weight of the deposit composition. The weight fraction of the ultrahigh molecular weight polymer constitutes from 0.2 to 5 percent by weight of the deposit composition, preferably from 0.5 to 3 percent by weight of the deposit composition.

The deposit composition can optionally comprise from 0.02 to 5 percent by weight of an inorganic binder replacing a like quantity of the functional phase particles. The deposit composition can optionally comprise between 0.02 and 5 percent by weight of an adjuvant replacing a like quantity of the functional phase particles. The weight percent of said the ultrahigh molecular weight polymer can be less than the weight percent of the functional phase particles. The functional phase particles are of average dimensions of less than five micrometers, preferably less than 100 nanometers. In some embodiments, the functional phase can be a conductor, such as, for example, silver. In some embodiments, the functional phase can be a dielectric. In some embodiments, the functional phase can be an insulator. In some embodiments, the functional phase can be a phosphor. in some embodiments, the dispersing vehicle can be water. In such embodiments the deposit composition containing the ultrahigh molecular weight polymer chosen from the group consisting of poly(ethylene oxide)s, and poly(acrylamide)s. In some embodiments, the dispersing vehicle can be a hydrocarbon. In such embodiments, the deposit composition the ultrahigh molecular weight polymer can be chosen from the group consisting of poly(α-olefins).

in some embodiments, two or more layers can be printed onto the substrate one atop the other. The consecutive layers can contain different active components or adjuvants. The surface of said substrate can be chemically modified to have a surface energy different than that of the natural surface energy of the substrate to make it more non-wetting to minimize spreading of the deposit composition.

In some embodiments the process can further comprise modifying a first portion of said substrate, wherein the first portion can be modified to have a surface energy that can be different than the surface energy on a second portion of the substrate, and wherein the first portion can be adapted to confine the deposit composition.

In some embodiments, the process can further comprise modifying a first portion of said the substrate, wherein the first portion can be adapted to confine the deposit composition. The deposit composition can be heated relative to the substrate. The surface of the substrate can be heated relative to the deposit composition. The deposit composition can be deposited into preformed channels on the substrate. The substrate can be rigid; for example, glass or ceramic. The substrate can be a semiconductor. The substrate can be flexible; for example, a polymer. The filament from the orifice can be touched to the substrate to establish adhesion between the filament and the substrate. The width of the resulting image can be modulated by modulating the draw ratio of the filament.

In general, it the spin printing techniques allow more rapid printing and the resulting lines can be finer than those obtained with ink jetting. Nonetheless, there may be particular applications where it can be desirable to interchange the two roles, using inkjetting to print the majority of the lines and to use spin printing to provide interconnects or other features.

### EXAMPLES

### General Techniques

The Jetlab® and Jetlab II® printers are manufactured by MicroFab® of Plano, Tex. They were equipped with the normal controllers and also outfitted with an optional four-jet head. One of the control packages allows very precise alignment of the jetting process with predetermined registration marks present on the surface of the substrate. The device is configured such that the printing heads (both ink jet and spin printing) are mounted on a gantry above a translation table. The translation table is capable of translating at high speed in the horizontal X and Y directions while ink is applied from the vertical Z direction. The translation table also capable of motion in the Z direction, but this motion is slow relative to the X and Y, and the Z dimension is generally fixed during any printing process to avoid collisions that can damage the heads, the substrate, or the translation table.

The silver nanoparticles used in the formulation were AgSphere®-2 from Sumitomo Electric USA, White Plains, N.Y. Diethyleneglycol and PEG 1500 are available from Aldrich Chemical, St. Louis, Mo. Sonication was carried out in a Branson Untrasonics (Danbury, Conn.) Digital Sonifier with a CE converter set at power level 4 with an ice/water bath for cooling. Dowanole DB was from Dow Chemical, Midland Mich. Filtration was carried out with Whatman 2.7 micron glass microfiber GF/D cat. NO. 6888-2527 (Whatman plc, Brentford, Middlesex, UK), followed by an OSMONICS® Cameo® 25NS nylon pore size 1.2 micron DDR12025S0 (Osmonics®, a subsidiary of General Electric Company, Fairfield, Conn.). Viscosities of the inks were measured at a shear rate of 76.8 s⁻¹ on a Brookfield DV-II+Pro Viscometer (Brookfield Engineering Laboratories, Middleboro, Mass. 02346-1031, USA) using the CPE-42 spindle (Shear Rate (s⁻¹)=3.84×Rotation Rate (rpm)). Surface tensions of the inks were measured on a KSV Sigma-70® tensiometer (KSV Instruments Ltd., Hoyläämotie 7, FIN-00380 Helsinki, Finland).

Spin Printing

A sample of UHMW polyethyleneoxide (2 g, Aldrich, Milwaukee, Wis. 18947-2, molecular weight about 5,000,000) was dispersed quickly into highly stirred hot water 50 mL) in a jar. The jar containing the UHMW PEO and water was placed onto a roller mill (U.S. Stoneware Corp., Palestine Ohio) set on its lowest speed. Tumbling for 65 hours produced a viscous, relatively homogeneous liquid or gel. The material could easily be drawn into long filaments.

A sample of Ferro silver (1.0 g) was dispersed in water (1 mL) in a 25 mL sample vial. A sample of polymer solution (1 mL) was added to the vial. Then an uncapped 1.5 mL vial was added to the sample vial. The sample vial was placed in a jar with padding and placed on the roller mill at its slowest speed for 24 hours.

The sample was transferred to one of the ink reservoirs on the Jetlab® and this reservoir was connected to a 60 micron ink jet. The electronic controls for this particular ink jet head were disconnected and the flow rate of the spin printing ink was controlled by means of the back-pressure regulation system available on the Jetlab®. Small samples were forced from the tip of the ink jet head. The head was translated across square glass plates at the higher machine speed making very straight, narrow lines. The polymer adhered well to the glass. Subsequent microscopic examination of the slides indicated that lines from 20-200 microns had been drawn and they had very smooth edges and good uniformity.

Ink Jetting

The components of the ink were added to a pear shaped flask and then stirred with a spatula to bring about mixing. The disrupter horn of a Branson probe sonicator was inserted into the flask such that it was partially immersed in the mixed fluid. An ice bath was positioned around the pear shaped flask such that any heat generated during sonication would be removed. The sonicator was activated in a pulsed mode with the duration and strength of pulses increasing from 0% to 100% and 5 W to 20-25 W respectively over the course of a 5 minute time period. The sonicator was then left in continuous (100%) mode at 20-25 W for a period of 30-45 minutes. The pear shaped flask was then removed from the ice bath, and the disrupter horn was removed from the pear shaped flask. The fluid was gently swirled in the flask to incorporate any solids around the fluid edge into the fluid, and a spatula was used to stir and loosen any solids that may have settled to the bottom of the flask. The disrupter horn was then reinserted into the flask, while the flask was repositioned in the ice bath for a second sonication period of 30-45 minutes at 20-25 W in continuous (100%) mode. Upon completion, the disrupter horn was removed from the sample, and the flask was removed from the ice bath.

The sample fluid was then transferred to a syringe, which was used to push the material through a series of 2 filters. The first was a glass fiber filter with a pore size of 2.7 microns while the second was a nylon filter with a pore size of 1.2 microns. This solution would then form the stock ink for a number of printings. Prior to printing, the portion of the stock solution to be used was filtered once again through a 1.2 micron nylon filter into the inkjet reservoir. The material was then placed under vacuum for approximately 15-30 minutes to remove any dissolved gases.

An ink comprising 50% Sumitomo Silver Powder, 0.5% Silwett L77®) surfactant, 3% PEG 200, 6.5% Dowanol DB®, and 40% water was formulated. The resulting mixture was sonicated for 30 min (Branson Digital Sonifier with a CE converter set at power level 4) with an ice/water bath for cooling. There were no detectable remaining solids and the suspension was filtered through the Millipore and Osmotics filters. The ink was degassed under vacuum for 30 min and then printed on a glass substrate using a Microfab Jetlab I inkjet system utilizing the control software available with the printer.

For ink jet printing, print conditions were typically set as follows:

Rise: 1-3 microseconds, Dwell: 3-8 microseconds, Fall: 1-3 microseconds, Echo Dwell: 3-8 microseconds, Final Rise: 1-3 microseconds, Dwell Voltage: 30-50V, Echo voltage: (−50)−(−30)V, Frequency: 400-1000 Hz, and Stage Speed: 20-100 mm/s. These setting typically gave drop velocities in the 2-3 m/s range. The print nozzle was typically held at a distance of approximately 1 mm from the surface to be printed. The nozzle itself usually had an orifice diameter in the 30-50 micron range. While the above settings are typical, printing could be accomplished outside the listed ranges with larger time periods typically giving larger drop sizes.

Dots of approximately 80 micron diameter were printed at a spacing of 70 microns between dots. A second layer of dots shifted by 50 microns from registration with the first layer was then printed. The initial dots were printed far enough apart to give a non-continuous image and the second layer connected all of the dots.

When the ink jet dots are printed parallel to and over the ends of the spin-printed lines, the width of the spin printed line is widened sufficiently to provide easy contact between the printed lines and clip-on electrical contacts that would be difficult to connect without the extra contact area.

When the ink jet dots are printed perpendicular to the spin-printed lines, they provide electrical continuity between the spin-printed lines so that they will act as relatively transparent shields for electromagnetic radiation. For this application, the individual printed lines need not be of high continuity or conductivity so long as there are sufficient interconnections between all of the lines that all portions of a potentially discontinuous line are connected.

What is claimed is:

1. A process for creating an image on a substrate comprising:
A. Spin printing, comprising:
a) continuously forcing a deposit composition comprising between 20 and 80 percent by weight of functional phase particles, a dispersing vehicle, and between 0.1 and 8 percent by weight of an ultrahigh molecular weight polymer that is soluble in that dispersing vehicle through an orifice to form a filament
b) optionally elongating that filament;
c) depositing that filament on the substrate to form a line; and
B. Inkjetting, comprising:
d) dropwise ejecting an ink composition comprising between 20 and 70 percent by weight of functional phase particles, a dispersing vehicle, and between 1 and 10 percent of dispersant polymer,
e) depositing those drops on the substrate connected to the line, and
C. evaporating the dispersing vehicle from the deposited filament and droplets resulting in the functional phase particles being affixed to the substrate in the desired image; and
D. optionally heating the substrate and deposited image to a temperature sufficient to effect removal of the organic components.
wherein steps A) and B) can be conducted in any order.

2. The process of claim 1 wherein either or both of A) and B) are repeated several times before conducting step C).

3. The process of claim 1 wherein there are a plurality of spin jets.

4. The process of claim 1 wherein there are a plurality of ink jets

5. The process of claim 1 wherein the inkjetted portion of the line is a terminal contact pad.

6. The process of claim 1 wherein there is one inkjet orifice per spin jet and the two are precisely aligned in the machine direction.

7. The process of claim 1 wherein there are one or more inkjet orifices per spin jet and they are precisely aligned in a manner offset from the spin jet with respect to the machine direction.

8. The process of claim 1 wherein A), B) and C) are carried out continuously.

9. The process of claim 1 where the functional phase is a conductor.

10. The process of claim 1 where the functional phase is silver.

11. The process of claim 1 wherein said dispersing vehicle is water.

12. The process of claim 1 in which two or more layers are printed onto the substrate one atop the other.

13. The process of claim 34 in which the consecutive layers contain different active components or adjuvants.

14. The process of claim 1 wherein said filament from the orifice is touched to the substrate to establish adhesion between the filament and the substrate.

15. An apparatus for creating an image on a substrate comprising a, bed with one or more gantries, each gantry bearing
a) a spin printing section consisting of a plurality of precisely-positioned spin jets mounted on one or more gantries supported above the bed of the apparatus,
b) an inkjet printing section consisting of a plurality of precisely-positioned ink jets mounted on one or more gantries supported above the bed of the apparatus,
the bed bearing a transport mechanism for transporting the substrate in a direction perpendicular to the direction of the gantries, the gantries spanning the transport mechanism, and optionally a heating or drying section.

16. The apparatus of claim 15 wherein the inkjets are piezoelectric.

17. The apparatus of claim 15 wherein there are one or more ink jets coaligned in the machine direction with each spin jet.

18. The apparatus of claim 15 wherein there are one or more ink jets offset with respect to the spin jet relative to the machine direction.

19. The apparatus of claim 15 wherein the ink jets and spin jets are mounted on the same gantry.

20. The apparatus of claim 15 wherein the ink jets and spin jets are mounted on separate gantries.

21. An article manufactured by the process of claim 1

22. An article of claim 21 wherein said article is selected from the group consisting of a display device, a plasma display panel, a field emission display device, a liquid crystal display device, a solar cell panel, an electrochemical cell, a printed circuit, an antenna, a shielding device for electromagnetic radiation, a resistance heater device for automobile windows, an electrochromic window device, microwave circuits, control modules, and EKG electrodes.

23. The article of claim 22 wherein said substrate is a polymer.

24. The article of claim 22 wherein said substrate is glass or ceramic.

25. The article of claim 22 wherein said substrate is a semiconductor.
